(19) United States
(12) Patent Application Publication
(10) Pub. No.: US 2014/0033551 A1
(43) Pub. Date: Feb. 6, 2014

(54) HAND HELD DEVICE HAVING A METAL ROD FORMING A ROTATIONAL AXIS

(71) Applicant: The Gillette Company, Boston, MA (US)

(72) Inventors: Andrew Anthony Szczepanowski, North Attleboro, MA (US); Florina Winter, Singapore (SG); Dong Fang, Shanghai (SH)

(73) Assignee: The Gillette Company, Boston, MA (US)

(21) Appl. No.: 13/957,548

(22) Filed: Aug. 2, 2013

Related U.S. Application Data
(60) Provisional application No. 61/679,471, filed on Aug. 3, 2012.

(51) Int. Cl. B26B 21/52

(52) U.S. Cl. CPC B26B 21/521
USPC 30/527

(57) ABSTRACT

A hand held device comprising: a handle, said handle comprising a grip portion and a connection portion, said connection portion rotating with respect to said grip portion about a rotational axis, said connection portion forming a docking portion suitable for receiving an optional head unit, said docking portion being positioned opposite distally away from said grip portion, wherein the grip portion and the connection portion are connected by a rod comprising a metal material, said rod comprising a distal end non-rotatably attached to the grip portion and a proximal end non-rotatably attached to the connection portion, wherein rotational axis forms a central longitudinal axis of said rod.

### BACKGROUND OF THE INVENTION

Some hand held devices such as safety razors have a head unit (such as a blade unit) connected to a handle for a pivotal movement about a single pivotal axis which is generally perpendicular to the major axis of the hand itself. The single pivotal axis can also be substantially parallel to the blade (i.e., the blade edge) when the device is a safety razor. For safety razors, the pivotal movement about the single axis provides some degree of conformance with the skin allowing the blade unit to easily follow the skin contours of a user during shaving. The pivot axis, which usually extends parallel to the cutting edges of the blades, can be defined by a pivot structure where the handle is connected to the blade unit. Such safety razors have been successfully marketed for many years. However, the blade unit often disengages from the skin during shaving as it has limited mobility able to pivot about only a single axis.

To address this problem, it has been suggested that the safety razors be provided with blade units that can additionally pivot about another axis which is substantially perpendicular to the blade(s). Such safety razors do provide improved conformance of the blade unit to the contours of the face during shaving.

While these safety razors which provide a blade unit that pivots about two axes help the blade unit to more suitably follow the contours of the face during shaving, they do not follow all the contours of the body during shaving. Various attempts to provide safety razors with multiple axes include: U.S. Pat. No. 4,152,828; 5,070,614; 5,526,568; 5,535,518; 5,560,106; 6,115,924; 6,311,400; 6,381,857; 6,615,498; 6,973,730; 7,140,116; 5,526,568; 5,033,152; and U.S. Patent Publ. No. 2008 034591; 2010 1013220, 2010 0313426, and 2011 0035950.

More recently WO 2011/131945 described a razor with a first axis substantially at 90° to the longitudinal body axis and a second axis which is substantially at 90° to the first axis and substantially aligned along or parallel to the longitudinal body axis. The reference discloses razors with biasing means which are shown as a pair diametrically positioned resiliently deforming members in the form of curved fingers made of plastic, rubber or spring steel. Rotation of the razor head part relative to the body such that force is applied onto the pair of fingers, thereby deforming them from an at rest position.

Thus, there is a need for a hand held device having a head unit capable of a pivotal movement about a pivot axis and rotational movement about a rotational axis which is suitable for use as hair removal device.

### SUMMARY OF THE INVENTION

One aspect of this invention relates to a hand held device comprising: a handle, said handle comprising a grip portion and a connection portion, said connection portion rotating with respect to said grip portion about a rotational axis, said connection portion forming a docking portion suitable for receiving an optional head unit, said docking portion being positioned opposite distally away from said grip portion, wherein the grip portion and the connection portion are connected by a rod, said rod comprising a metal material, said rod comprising a distal end non-rotatably attached to the grip portion and a proximal end non-rotatably attached to the connection portion, wherein rotational axis forms a central longitudinal axis of said rod, preferably the device can be a safety razor or another personal care, grooming or beauty care device.

A hand held device comprising: a handle, said handle comprising a grip portion and a connection portion, said connection portion rotating with respect to said grip portion about a rotational axis, said connection portion forming a docking portion suitable for receiving an optional head unit, said docking portion being positioned opposite distally away from said grip portion, wherein the grip portion and the connection portion are connected by a rod comprising a metal material, said rod comprising a distal end non-rotatably attached to the grip portion and a proximal end non-rotatably attached to the connection portion, wherein rotational axis forms a central longitudinal axis of said rod, wherein the rod is permanently attached to at least one of said grip portion and said connection portion, wherein the end of the rod which is not permanently attached is removably attached to the other of said grip portion and said connection portion, and wherein said blade unit has a maximum rotation of from about 10° to about 30°, or more preferably about 15°.

### BRIEF DESCRIPTION OF THE DRAWINGS

FIG. 1 is a side view of a hand held device in accordance with at least one embodiment of the present invention.

FIG. 2 is a side view of another hand held device in accordance with at least one embodiment of the present invention.

FIG. 3 is a side view of the hand held device of FIG. 2, with the head unit partially rotated. The relative movement of the surface indicia in these exemplary figures is provided to more clearly show the rotational movement.

FIG. 4 is a bottom view of a hand held device in accordance with at least one embodiment of the present invention. In this example, the device is a safety razor.

FIG. 5 is a top view of the device shown in FIG. 4.

FIG. 6 is a top view of another hand held device in accordance with at least one embodiment of the present invention.

FIG. 7 is a frontal view of a hand held device in accordance with the present invention

FIG. 8 is a frontal view of the device of FIG. 7 where the razor head is pivoted back.

FIG. 9 is another frontal view of the device of FIG. 7, with the razor head rotated counterclockwise.

FIG. 10 is another frontal view of the device of FIG. 7, with the razor head rotated to the clockwise.

FIG. 11 is another frontal view of the device of FIG. 7, with the razor head pivoted back and rotated counterclockwise.

FIG. 12 is another frontal view of the device of FIG. 7, with the razor head pivoted back and rotated clockwise.

FIG. 13a-13c are side views of various rods in accordance with at least one embodiment of the present invention.

FIG. 14 is a side view of yet another rod in accordance with at least one embodiment of the present invention.

FIGS. 15a-15b are side views of a rod at rest and having one end rotated.

FIGS. 16a-16b are side views of a rod at rest and having one end rotated.

FIG. 17 is another rod in accordance with at least one embodiment of the present invention.

FIG. 18a is a top view of a finger pad in accordance with at least one embodiment of the present invention.

FIG. 18b is a cross section view of the finger pad of FIG. 18a taken along view line A-A.

FIG. 19 is another top view of a finger pad.

FIG. 20a is a top view of another finger pad in accordance with at least one embodiment of the present invention.

FIG. 20b is a cross section view of the finger pad of FIG. 20a taken along view line B-B.

FIG. 21 is a graph of rotation back to an at rest position over time for various example razors when tested in a wet environment (simulating in use conditions).

### DETAILED DESCRIPTION OF THE INVENTION

The present invention addresses the need for a hand held device having a head unit capable of a pivotal movement about a pivot axis and rotational movement about a rotational axis which is suitable for use as hair removal device by providing a handle comprising a grip portion and a connection portion, said connection portion rotating with respect to said grip portion about a rotational axis, wherein the grip portion and the connection portion are connected by a rod comprising a metal material, said rod comprising a distal end non-rotatably attached to the grip portion and a proximal end non-rotatably attached to the connection portion, wherein rotational axis forms a central longitudinal axis of said rod, and wherein said connection portion forming a docking portion suitable for receiving an optional head unit, such as a blade unit, said docking portion being positioned opposite distally away from said rod and/or said grip portion. In one embodiment, the device comprises only a single rod, or multiple smaller rods positioned together to form a larger composite rod like a braided or unbraided band of rope, or layered over one another like a coated wire or a layered cake. Importantly, it is believed that having a central rod made up of one or more individual rods provides for a central point of biasing resistance for consistent and steady performance when the device is put into a stressed position and when is biased back into an original at rest position. Without intending to be bound by theory, it is believed that having multiple biasing members positioned at different locations allows for varying actors to apply biasing force which can lead to different biasing pressures depending on which way and how the device is pivoted. Further, if one biasing member begins to fatigue before the other, that can also lead to inconsistent performance depending which way the device components are pivoted.

As defined herein, non-rotatably attached means that the end of the rod attached the either the grip portion or the connection portion rotates with the handle portion to which it is attached. This means that the proximal end of the rod is attached and rotates with the connection portion with respect to the grip portion, while the distal end of the rod is attached to the grip portion and stays stationary with the grip portion, with respect to the rotating connection portion. Those of skill in the art will understand that the relative rotation of one end against the other causes the rod to twist which can happen along the rod body. Rotation of one end of the rod versus the other will thereby allow the grip portion or the handle portion to rotate with respect to the other. Further, in one embodiment, both ends of the rod can simultaneously rotate in opposite directions (clockwise and counterclockwise), or they can rotate in the same direction but one can rotate faster than the other, thereby still creating a twist in the rod body.

The metal material used in the rod is of particular importance because of how it returns to the original at rest position following removal of an applied force. This behavior is captured in the stress relaxation profile of the rod. This stress relaxation profile will be discussed below in more detail.

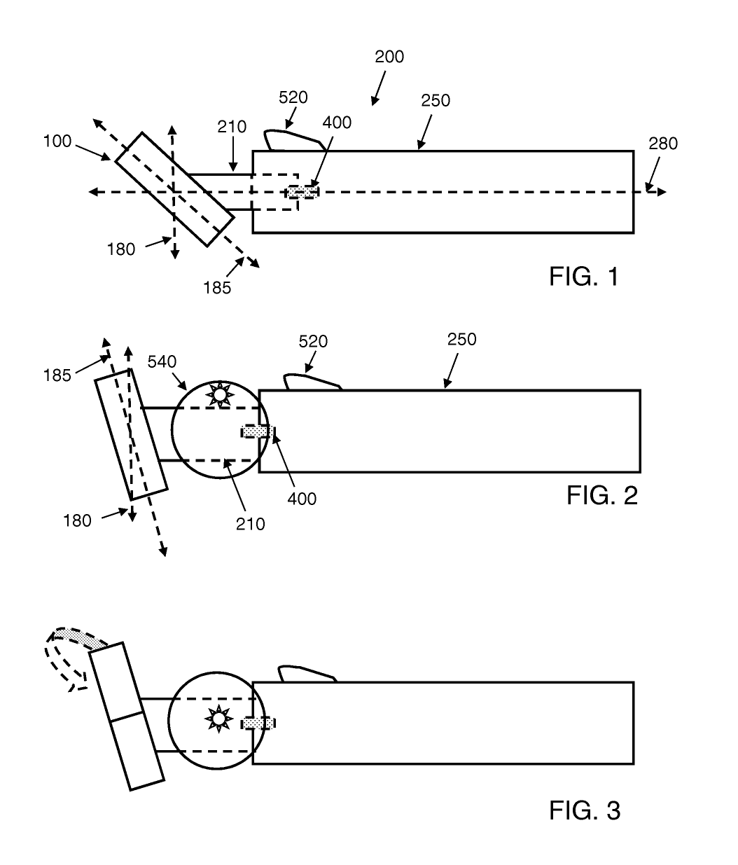

FIG. 1 is a side view of a hand held device in accordance with at least one embodiment of the present invention. FIG. 1 shows a handle (200), said handle comprising a grip portion (250) and a connection portion (210), said connection portion rotating with respect to said grip portion about a rotational axis (280), said connection portion (210) forming a docking portion (218) suitable for receiving an optional head unit (100), said docking portion (218) being positioned opposite distally away from said grip portion (250), wherein the grip portion and the connection portion are connected by a rod (400), said rod comprising a distal end (450) non-rotatably attached to the grip portion (250) and a proximal end (410) non-rotatably attached to the connection portion (210), wherein rotational axis (280) forms a central longitudinal axis of said rod (480). Also shown in FIG. 1 is an optional finger pad (520) positioned on the upper surface of the grip portion. The finger pad can be particularly useful to allow for enhanced user feel and control given the various types of rotation and pivoting possible with the present device. In one embodiment, the finger pad is positioned such that the pressure point of the finger pad is over at least a portion of the rod. The pressure point of the finger pad is the central area of applied pressure which a user's finger will create when they push on the finger pad. Preferably the pressure point will be in over the rotational axis (280). As long as the finger pad and or its pressure point sits directly above the rotational axis the user can still have a desirable amount of control during use. The rod need not be present under the finger pad as it can sit closer to the connecting portion or closer to the interior of the grip portion.

The head unit (100) can include a wide scraping surface such as where the hair removal device is used with a depilatory or for skin exfoliation, or a blade unit, such as where the device is a safety razor. Where the hair removal head is a razor cartridge the cartridge may also include multiple blades. For example, U.S. Pat. No. 7,168,173 generally describes a Fusion® razor that is commercially available from The Gillette Company which includes a razor cartridge with multiple blades. Additionally, the razor cartridge may include a guard as well as a shaving aid. A variety of razor cartridges can be used in accordance with the present invention. Nonlimiting examples of suitable razor cartridges, with and without fins, guards, and/or shave aids, include those marketed by The Gillette Company under the Fusion®, Venus® product lines as well as those disclosed in U.S. Pat. Nos. 7,197,825, 6,449,849, 6,442,839, 6,301,785, 6,298,558; 6,161,288, and U.S. Patent Publ. 2008/060201.

As shown in FIG. 4, where the head unit (100) is a said blade unit, the blade unit comprises a guard (140), a cap (150), at least one blade (110) positioned between the guard and the cap and a transverse centerline (185) extending through the guard and the cap in a direction substantially perpendicular to the at least one blade. “Substantially perpendicular” as defined herein means that when the device is in an at rest position (no external forces are applied to any parts of the device), where a first line intersects a second line, the intersecting line forms an angle of from about 85° to about 90°, or from about 88° to about 90°×0.1°. The transverse centerline divides the blade unit into substantially equal right half (184) and left half (182), as shown in FIG. 8.

The blade unit (100) pivots with respect to the connection portion (210) about a pivot axis (180) that extends substantially parallel to the at least one blade (110). Where the head unit does not have a blade, it may still have an elongated scraping surface or edge or at least a lateral dimension which runs across the width of the head unit. “Substantially parallel” as defined herein means that when the device is in an at rest position (no external forces are applied to any parts of the device), the two lines sit on a plane but do not intersect or meet. Those of skill in the art will understand that the blade(s) and or head unit can have a slightly curved shape as such, substantially parallel means if a straight line were to be drawn through the at least one blade, that line is parallel to the pivot axis. The pivot axis can reside in front of the blades and below a plane tangential to the guard and cap. Other pivot positions are also possible. The blade unit may have a pivot range up to about 45° about pivot axis (180). Other pivot ranges both larger and smaller may be used if desired.

In one embodiment, the rotational axis (280) intersects at least one of said pivot axis and said transverse centerline (185) of the blade unit. Preferably, the rotational axis intersects at least the transverse centerline. Without intending to be bound by theory, the intersection of the rotational axis and the transverse centerline ensures that as rotations occur, the head unit rotates uniformly so that the portion rotating on the left is equal to the portion rotating on the right. Without intending to be bound by theory, it is also believed that this intersection aligns the head unit with the handle to provide a balanced hand held device. The intersection allows the right half (184) and left half (182) to rotate equally from one side to the other about handle (200). The connection portion (210) and accordingly the blade unit (100) may have a rotation range up to about 30° about rotational axis (280), e.g., about 15° in one direction and about 15° in the opposite direction. In one embodiment, the rotation range can be less than 30°, such as 20°. The rotation range can also be greater, for example up to 90°.

In one embodiment, the rotational axis (280) and the pivot axis (180) may intersect one another. Alternatively, the rotational axis may be spaced from the pivot axis, at their closest measured distance, by a distance of less about 10 mm, preferably less than about 5 mm. The closer the rotational axis (280) is to the pivot axis (180) the user has more control over the movement of the head unit (100) during use—this can be particularly useful in a shaving context as controlled pivoting and rotation of the blade unit can be important to certain users.

The terms “forward” and “aft”, as used herein, define relative position between features of the blade unit (i.e., razor cartridge). A feature “forward” of the at least one blade, for example, is positioned so that the surface to be treated with by the device encounters the feature before it encounters the at least one blade. For example, if the device is being stroked in its intended cutting direction, the guard is forward of the blade(s). A feature “aft” of the blade(s) is positioned so that the surface to be treated by the device encounters the feature after it encounters the blade(s), for example if the device is stroked in its intended cutting direction, the cap is disposed aft of the blade(s).

In one embodiment, the guard comprising at least one elongated flexible protrusions to engage a user's skin. In one embodiment, at least one flexible protrusion comprises flexible fins generally parallel to said one or more elongated edges. In another embodiment, said at least one flexible protrusion comprises flexible fins comprises at least one portion which is not generally parallel to said one or more elongated edges. Non-limiting examples of suitable guards include those used in current razor blades and include those disclosed in U.S. Pat. Nos. 7,607,230 and 7,024,776; (disclosing elastomeric/flexible fin bars); 2008/0034590 (disclosing curved guard fins); 2009/0049695A1 (disclosing an elastomeric guard having guard forming at least one passage extending between an upper surface and a lower surface).

In one embodiment, the blade unit comprises at least one skin engaging member such as a conventional shave aid or lubrication strip. The skin engaging member can be positioned forward of the blade(s) and/or aft of the blade(s). Non-limiting examples of known skin conditioning compositions suitable for use herein include shave aids and lubrication strips as described in: U.S. Pat. Nos. 7,581,318, 7,069,658, 6,944,952, 6,594,904, 6,302,785, 6,182,365, D424,745, 6,185,822, 6,298,558 and 5,113,585, and 2009/0223057.

In one embodiment, the skin engaging member comprises a skin conditioning compositions comprises at least one emollient and a water insoluble structuring polymer forming an erodible, solid moisturizing composition. Examples of such compositions have been described as an erodible, solid moisturizing composition described in copending U.S. Patent Publication Nos. 2011/0197448 and 2011/0197449 both to Stephens et al. In one embodiment, the skin engaging member can form a continuous or partial ring around the blade(s) as described in U.S. Patent Publication No. 2012/0090179. Without intending to be bound by theory, this can be particularly useful to ensure that any skin conditioning compositions such as moisturizers and/or lubricants can be deposited on the surface to be treated even throughout the various types of motion and rotation possible with the present device.

FIG. 2 is a side view of another hand held device in accordance with at least one embodiment of the present invention. This embodiment has a similar head unit to that shown in FIG. 1 for illustrative purposes of the pivot action of the head unit about pivot axis (180). In this figure, the head unit pivoting such that the portion with the cap pivots towards the handle, while the portion with the guard pivots away from the handle. Also shown in this figure is a finger pad (520) positioned on the upper surface of the grip unit of the handle. In this embodiment, the connecting portion (210) does not have a region sitting inside the grip portion (250) (as shown in FIG. 1). In another embodiment, a portion of the grip portion can protrude into the connecting portion and the rod can be positioned beyond the farthest reaching portion of the grip portion. In FIG. 2, the connecting portion and the grip portion form a surface interface. The rod (400) extends into each portion and allows the portions to rotate with respect to the other.

Also shown in FIG. 2 is a cap member (540) which can be used to cover a portion of the interface between the connecting portion (210) and the grip portion (250). In one embodiment, the cap member has a rounded or oval shape. Preferably, the cap member rotates along with the connecting portion (210) about the rotational axis (280). In one embodiment, the cap member has a central axis which can overlap with the rotational axis such that during rotation of the connecting portion, the cap member does not move but merely rotates. FIG. 3 is a side view of the hand held device of FIG. 2, with the head unit partially rotated. The relative movement of the surface indicia (shown as a sun) and the cap member in a downward rotation from the viewing perspective in these exemplary figures is provided to more clearly show the rotational movement. An arrow showing rotation has also been provided. As shown here, the connecting portion (210) forms a docking portion (218) for receiving the head unit.

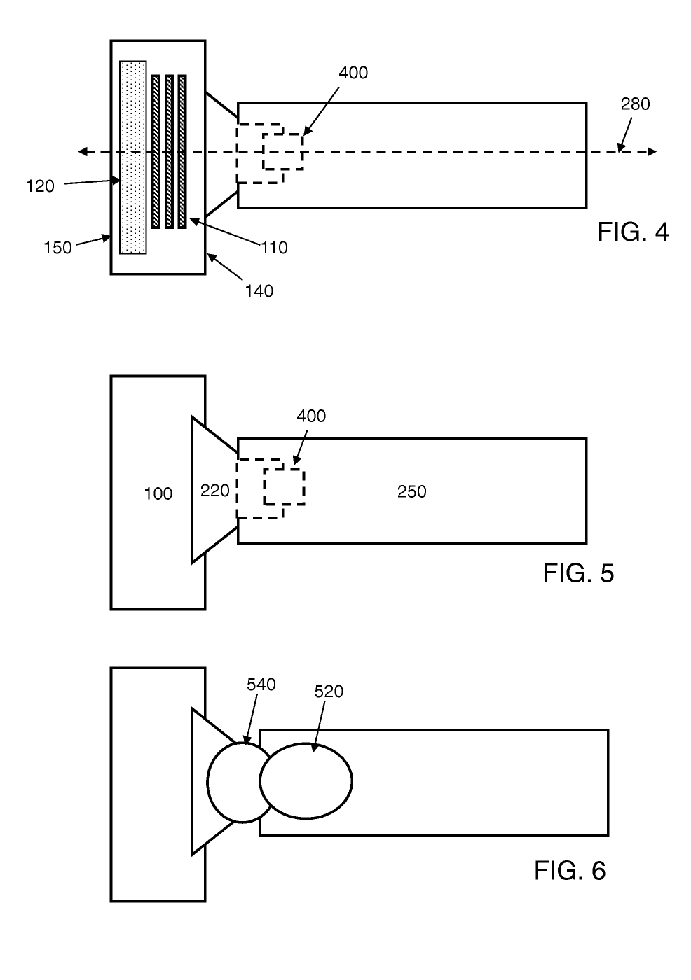

FIG. 4 is a bottom view of a hand held device in accordance with at least one embodiment of the present invention. In this example, the device is a safety razor with a blade unit comprising three blades (110) and a shaving aid (120) positioned aft of said blades. Cap (150) is further aft of the shaving aid and the guard (140) is forward of the blades. FIG. 5 is a top view of the device shown in FIG. 4.

FIG. 6 is a top view of another hand held device in accordance with at least one embodiment of the present invention. FIG. 6 shows a cap member (540) and a finger pad (520).

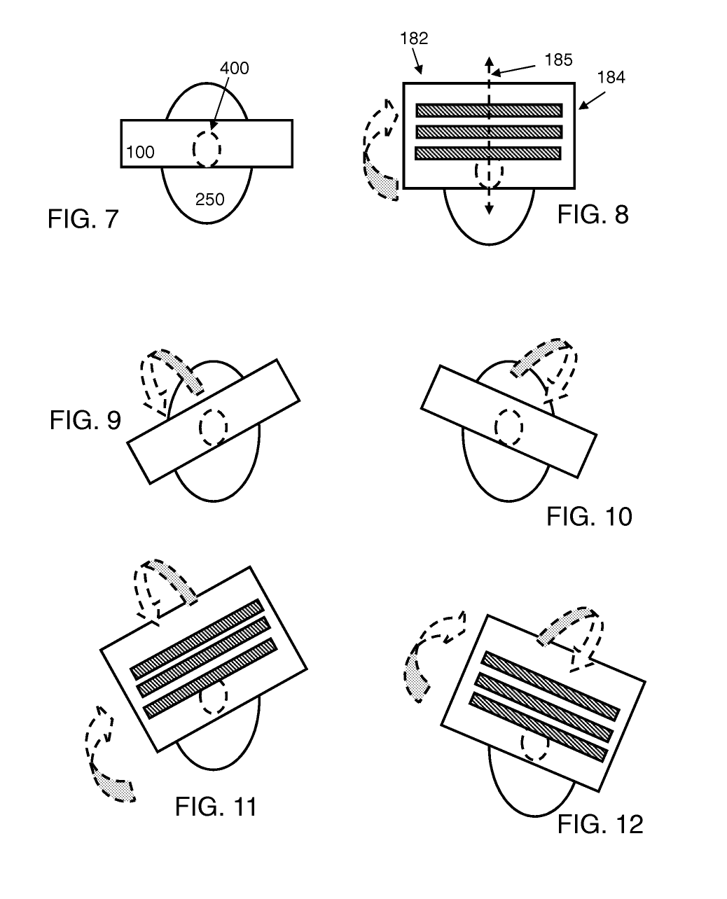

FIGS. 7-12 show a frontal view of a safety razor in accordance with the present invention. FIG. 7 is in an at rest position where the blade unit (100) is not pivoted or rotated. The central longitudinal axis of the rod (not shown) overlaps with the rotational axis (not shown). FIG. 8 shows the same razor but pivoted so the cap of the blade unit approaches the handle (250). Also shown in FIG. 8 is the transverse centerline which separates the blade unit into substantially equal left half (182) and right half (184).| FIGS. 9 and 10 show the blade unit not being pivoted but the connecting portion and blade unit being rotated counterclockwise, and clockwise, respectively. FIG. 11 shows counterclockwise rotation with pivoting. FIG. 12 shows clockwise rotation with pivoting.

In one embodiment, the head unit has a maximum rotation of from about 5° to about 90°, preferably from about 10° to about 30°, preferably about 15° from an at rest position, ±1°. Without intending to be bound by theory, it is believed that a maximum rotation of about 15° is particularly desirable for a razor execution.

Rod

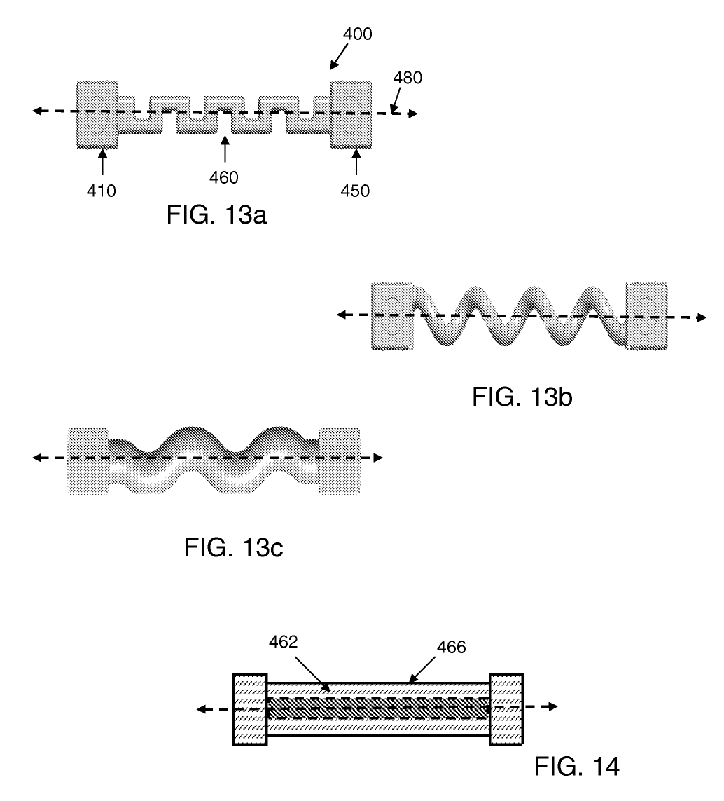

FIGS. 13-14 show different versions of suitable rods for use in accordance with the present invention. Between distal end (450) and proximal end (410) is rod body (460). Various shapes for the ends and rod body can be used. The rods of FIGS. 13a and 13b have oscillating wave patterns with a squared or rounded cross sectional area, respectively. The rod of FIG. 13b is like a spring. The body (460) of the rod of FIG. 14 is cylindrical.

As explained above and shown in the figures, at least a portion of the rotational axis of the hand held device forms a central longitudinal axis of said rod. As the connecting portion of the device rotates with respect to the grip portion, the rotation occurs about the rotational axis and the central longitudinal axis of the rod. In effect, the rod becomes a spine, about which the connecting portion and the optional head unit, can rotate in a clockwise or counterclockwise orientation with respect to the grip portion. The flexible and twistable nature of the rod allows for torsional rotation but creates a biasing force to return the device back to an at rest orientation. It has importantly been found that a rotation range of from about 0° to about 45°, preferably from about 0° to about 30°, most preferably from about 0° to about 15°, as measured from the at rest position, is suitable for various uses, such as when the hand held device is a wet or dry power or manual shaving razor and the head is either disposable or replaceable. In one embodiment, rotating said connection portion from a zero potion by 15° generates from about 15 Nmm to about 40 Nmm of torque±0.1 Nmm, preferably from about 22 Nmm to about 35 Nmm±0.1 Nmm. Without intending to be bound by theory, it is believed that this provides a desired range of torsional resistance during use such that the user can feel the return force biasing the head and connecting portion back to an at rest 0° orientation. Those of skill in the art will understand that greater or less torsional resistance can be desired based on user preference.

In these exemplary figures, the ends are squared so they can be placed into receiving regions of the connecting portion and grip portion so they become non-rotatably attached thereto. The body portion (460) twists as the connecting portion and grip portion rotate with respect to one another. In one embodiment, the ends have the same shape, such as a square or rectangular shape. In another embodiment the ends have different shapes, as long as the end can be non-rotatably attached to one of said connection portion or said grip portion. In another embodiment, one or both of the ends have the same cross sectional shape as a portion of the rod body. For example, the entire rod has the same cross sectional shape, such as a cylinder or an elongated rectangle.

In one embodiment, one or both of the ends can be non-rotatably attached to the portion of the handle by a fitting into a receiving space within the respective portion. In another embodiment, the receiving space can further form a protrusion which fits into a void space within the end, such as a pin which can fit into void in the end, or vice versa where the protrusion is formed in the end and fits into a void in the receiving region of the portion of the handle.

In one embodiment, the rod is permanently attached to at least one of said grip portion and said connection portion. Where the rod is permanently attached to one of said grip portion and said connection portion, it can be integrally formed with said respective grip portion or said connection portion. “Integrally formed”, as used herein means that two structures are formed together as part of the same single step or multiple step making process, such as where the structures are molded together or in a multi-shot mold, or where the two structures are separately formed then permanently affixed to each other before being assembled with any other portions of the device.

In one embodiment, the rod and respective portion of the handle to which it is integrally formed is affixed via any known method for attaching two structures, including but not limited to via an adhesive, a heat seal, or by ultrasonic welding. In one embodiment, the rod and respective portion of the handle to which it is non-rotatably attached is permanently affixed via one of the previously mentioned methods but the structures need not be integrally formed (meaning that the attachment can occur after other structures of the device are already assembled). The permanent attachment can be by integrally forming as described above.

In one embodiment, both ends of the rod can be permanently attached to each of their respective portions of the handle. Preferably, only one of the ends would be integrally formed with its respective handle portion. In this example, it may be useful to have the rod integrally formed with the connecting portion but the rod can also be integrally formed with the grip portion as well.

In one embodiment, only one end of the rod is permanently attached to its respective portion of the handle. The end of the rod which is not permanently attached can be removably attached to the other of said grip portion and said connection portion. “Removably attached” means that the attachment can be by a structural attachment such as a fitment where the end anchors or hooks into or onto the receiving region of the portion of the handle, or the protrusion/void or male/female mating system described above. In one embodiment, the distal end is permanently attached to the grip portion and the proximal end is removably attached to the connection portion. The reverse could also be possible where the distal end is removably attached and the proximal end is permanently attached. In another embodiment, the rod is removably attached to both of said grip portion and said connection portion.

The rod of the present invention comprises a metal material. In particular, it has been found that using a metal material provides advantages over rods made solely of plastic or polymeric materials. One of the inherent problems with plastic is stress relaxation and creep. Stress relaxation is the ability of a spring or other structure to deform under applied force and then return to its original state following removal of that applied force. Depending on the duration for which the force is applied, and the environmental conditions (varying pressures and temperatures), springs formed from different materials will have different stress relaxation profiles. It has been found that the metals of the present invention return to the original at rest position better than rods made of plastics.

Material creep or long term deformation is another issue that has been encountered with plastic materials. This issue can be exacerbated in certain in use conditions such as when shaving in a hot or humid environment. In particular, some users will tend to expose razors to hot then cold water during their shaving processes. These quick changes in environmental temperature are believed to exacerbate creep issues as the quick cooling can cause a rod to take a new shape or orientation over time. Further, without intending to be bound by theory, it is believed that plastics typically have a low resistance to long-duration applied strains. Over time they can establish a permanent deformation where the material does not return to its original state once a load is removed.

It is believed that metals, particularly those of the present invention, are believed to be less susceptible to material creep and such deformations. It is believed that metal materials are better springs due to their bulk properties, higher yield strength and abilities to improve their elastic limit through tempering. These material properties enable a metal spring to be loaded to a higher stress without passing the limit where the deflection becomes plastic.

In an embodiment where the rod comprises one or more metal materials, it can be advantageous to limit the extent of rotation of the rod. Certain metals, which may provide desirable stress relaxation and resilience to creep may have more limited range of rotational deformation. As such, one embodiment of the present invention limits the rotation range of from about 0° to about 15°, in either clockwise or counter clockwise rotation. This is believed to be helpful to ensure a rod comprising metal will return to the at rest position properly and over the suggested lifespan of the product, potential from about 3 to about 5 years, maybe even longer.

In one embodiment, the metal material is tempered to increase the strength and ability to perform as a biasing member. In one embodiment, the metal has a minimum ¼ hard steel or stainless steel up to fully hard steel or stainless steel, preferably ¾ hard. In another embodiment, the rod is selected so it has a specific thickness of from about 0.1 mm to about 0.5 mm, preferably from about 0.2 mm to about 0.4 mm, preferably from about 0.30 mm to about 0.35 mm. The tolerances of the thickness can be ±0.01 mm. It is believed that tolerances beyond 0.01 mm can lead to undesirable variations in the spring or biasing features of the rod. Thickness is measured as the longest lateral dimension perpendicular to the central longitudinal axis of said rod. In one embodiment, the rod has a length (the longest longitudinal measurement of the rod along the central longitudinal axis) of from about 2 mm to about 4.5 mm, preferably from about 2.5 mm to about 4 mm, preferably from about 3 mm to about 3.8 mm.

Non-limiting examples of suitable metal materials include one or more of the following: steel, stainless steel, X5CrNi18 10/X5CrNi18 8 (1.4301), X5CrNiMo17 13 3/X3CrNiMo17 13 3 (1.4436), X5CrNiMo171 12 2 (1.4401), X1NiCrMoCuN25 20 5 (1.4539), X7CrNiAl17 7 (1.4568), X6CrNiMoTi17 12 2 (1.4571), CuZn37 (CW508L; 2.0321), CuZn36 (CW507L; 2.0335), CuSn6 (CW452K; 2.1020), CuBe 2 (CW101C; 2.1247), NiMo16Cr16Ti (2.4610), NiCr15Fe7TiAI (2.4669), NiCr20Co18Ti (2.4632), Duratherm CoNiCrFe, VDC Oil tempered valve spring (1.1250; EN 10270-2), VDCrV Oil tempered valve spring (1.1250; EN 10270-2), VDSiCr Oil tempered valve spring (1.1250; EN 10270-2), and composites or laminates thereof. Those of skill in the art will understand that these are different forms of metals. The numbers or codes in the brackets are alternative international codes for that material. The last three VDC oil tempered materials are different materials and the EN norm is shown explaining the difference for those of skill in the art.

The metal can also be galvanized or otherwise coated or treated to help with resilience to degradation such as rust.

In one embodiment the rod comprises a single metal material of 301 stainless steel ¾ hardened with a thickness of about 0.30 mm and a length of about 3.8 mm. In another embodiment the rod comprises a single metal material of 301 stainless steel ¾ hardened with a thickness of about 0.35 mm and a length of about 3.0 mm.

In one embodiment, the device comprising a rod comprising metal as defined herein provides a static stiffness in a range of about 1.25 N*mm/degree to about 1.65 N*mm/deg, as determined by the Static Stiffness Method as defined in U.S. patent application Ser. No. 13/444,886 titled “HAND HELD DEVICE HAVING A ROTATIONAL AXIS”, to Dong Fang et al, filed Apr. 12, 2012. In another embodiment, the handle has a damping of from about 0.13 N*mm*seconds/degree to about 0.16 N*mm*sec/degree, as determined by the Pendulum Test Method as defined in U.S. patent application Ser. No. 13/444,886 titled “HAND HELD DEVICE HAVING A ROTATIONAL AXIS”, to Dong Fang et al, filed Apr. 12, 2012, and a primary momentum of inertia of moving handle parts of from about 0.05 kg*mm̂2 to about 1 kg*mm̂2. In another embodiment, the handle, further comprising a primary momentum of inertia of all moving parts in a range of 0.5 kg*mm̂2 to 3 kg*mm̂2, preferably about 1 kg*mm̂2 to about 2 kg*mm̂2, most preferably about 1.2 kg*mm̂2. The handle can be sized such that wherein a shortest distance from rotational axis to the pivot axis of the head unit is in a range of about 0 mm to about 10 mm.

In one embodiment, the rod further comprises a polymeric material. Any polymeric material suitable for use in a hand held device which is flexible and can torsional stress which can occur during use without breaking can be used. In one embodiment, the polymeric material is selected from the group consisting of: an acetal, a polyacetal, a polyoxymethylene, polyphenylene sulfide, a polyamide, a polybutylene terephthalate, a thermoplastic elastomer, a polyurethane, a silicone, a nitrile rubber, and a mixture thereof. In one embodiment of the present invention, the polymeric material comprises polyoxymethylene, commercially available as Delrin DE9422 from DuPont®.

In one embodiment, the rod comprises a first layer and a second layer. The layers can be in the form of a central core and a sheath layered externally to the central core. FIG. 14 shows such an example where first layer first layer (462) laminated with a second layer (466). In another embodiment, layers can just be laminated onto one another as two sheets forming the rod. In one embodiment, the first layer and the second layer are not made of the same material, for example the first layer can be steel and the second layer can be the polymeric material. Different types of metal materials can also be used to form the different layers. In another embodiment, the rod is formed of just a single material.

In one embodiment, the material forming a portion of the rod have a Young's modulus of from about 0.01 GPa to about 200 GPa, preferably from about 0.01 GPa to about 10 GPa.

Without intending to be bound by theory, it is believed that believed that using a material with such a Young's modulus has desirable elastic properties for use with the device of the present invention. Those of skill in the art will understand that Young's modulus is an intrinsic property. Depending on the specific type of material(s) used the shape and amount of the material can be modified to provide the desired rotational resistance desired.

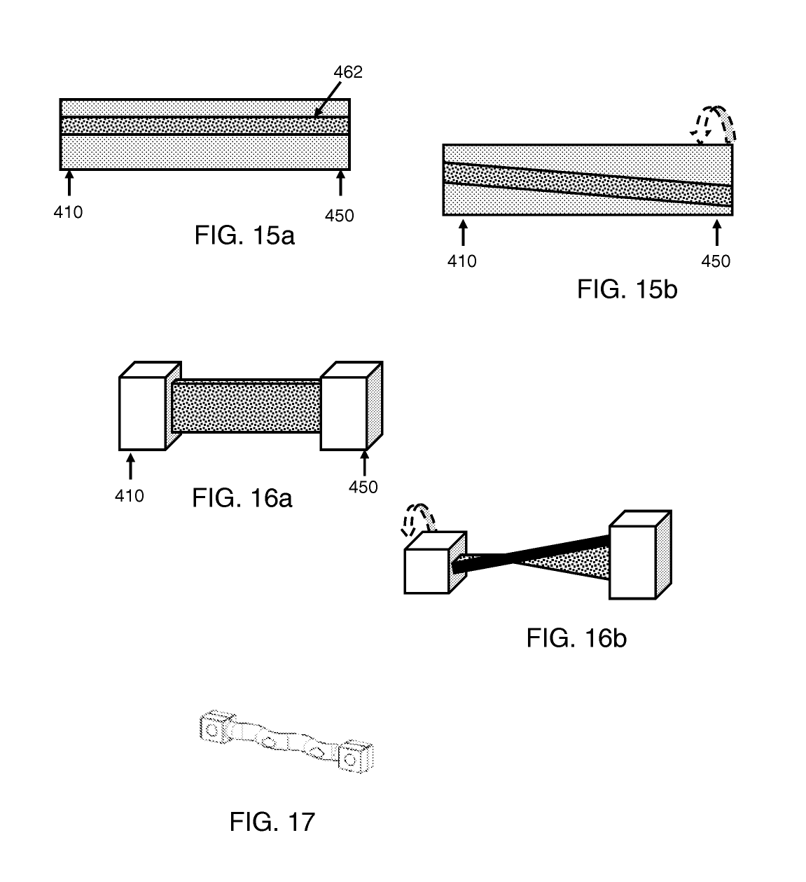

FIGS. 15a and b show exterior views of a cylindrical rod or at least a rod body having a surface marking line (462). The rod in 15a is at rest while the rod of 15b is partially rotated. In 15b, as the distal end (450) is at least partially rotated, while the proximal end is held still, surface marking line (462) shows the twisting deformation of the rod. One of skill in the art will understand that although the proximal end and distal end are shown having the same shape as the rest of the rod body, the ends can have different shapes.

FIGS. 16a and 16b show another rod in accordance with at least one embodiment of the present invention, wherein the proximal end (410) is rotated by 90° such that the rod body twists while distal end (450) stays stationary and does not rotate. As shown in this embodiment, the rod can be relatively thin in terms of thickness or width but be long so the rod has a generally thing rectangular shape. In one embodiment, the rod body can be layered along the width of the body such that the layers form a laminate like a layered stick of gum from Trident®. In another embodiment, the rod body can be layered along the height of the rod body like a multi-layered cake.

FIG. 17 is another rod in accordance with at least one embodiment of the present invention. The rod body of this embodiment can have one or more apertures formed throughout the length of the rod body. Furthermore, the rod body it self can form oscillating waves in and out of the viewing plane when viewed from a side view. As such, in one embodiment, the rod body can be corrugated and/or form one or more apertures.

Finger Pad

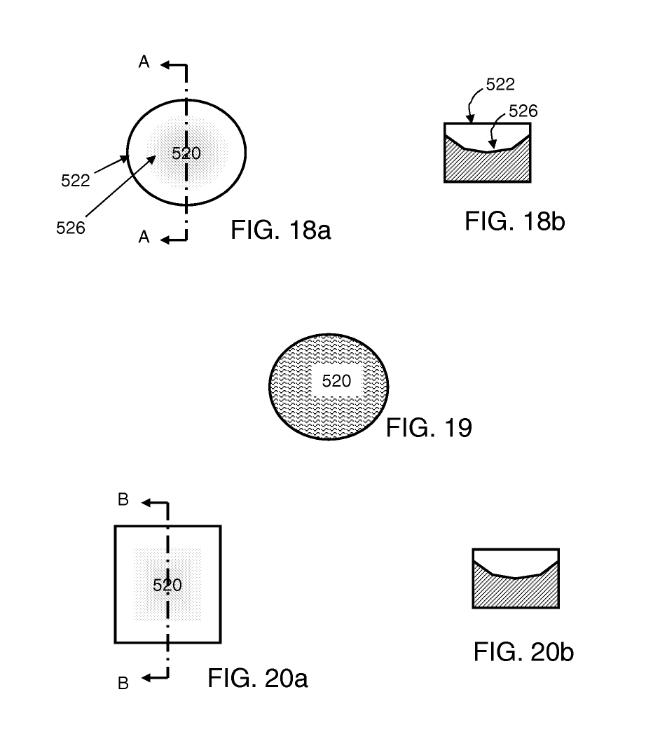

FIG. 18a is a top view of a finger pad (520) in accordance with at least one embodiment of the present invention. The finger pad (520) has an oval shape and an interior region (526) with raised side walls (522). FIG. 18b is a cross sectional view of the finger pad of FIG. 18a view along view line A-A. The interior region (526) is recessed so it sits lower than the raised side walls (522) such that a user placing a finger into the finger pad can press down into the middle of the finger pad but also apply lateral pressure against the front portion or side portions of the raised side walls (522). This can be particularly useful since the device of the present invention allows for pivoting and rotation of the head. Without intending to be bound by theory, it is believed that the finger pad allows for added control as the head unit contours over the surface it is being engaged over. For example, where the device is a safety razor, the finger pad allows the user to maintain control while contouring the blade unit by pivoting and/or rotating.

FIG. 19 is another top view of a finger pad. In one embodiment, the finger pad can be textured to increase traction to the finger. Any suitable texture can be used such as dimpling or scored or raised in a linear or cross hatch orientation.

FIG. 20a is a top view of another finger pad (520) in accordance with at least one embodiment of the present invention. This finger pad has a square or rectangular shape. Other shapes can also b used, such as a triangular shape. FIG. 20b is a side view of the finger pad of FIG. 20a view along view line B-B. This embodiment can also have a recessed interior region with raised side walls.

The finger pad can be placed such that it sits atop a portion of the rod when the device is viewed from a top view similar to FIG. 6. The finger pad need not be placed over the rod but the finger pad should have a central axis which is parallel with the rotational axis and is positioned above said rotational axis when the device viewed from a top view as shown in FIG. 6.

In one embodiment, the device comprises a window formed in one or both of the connecting portion and the grip portion. In one embodiment, the finger pad can be clear or transparent such that it forms the window. In another embodiment, the device comprises the finger pad and a separate window. In one embodiment, a portion of said rod, such as the rod body, or all of said rod is exposed via a window formed in said grip portion, said connecting member, or a combination thereof.

Stress Relaxation

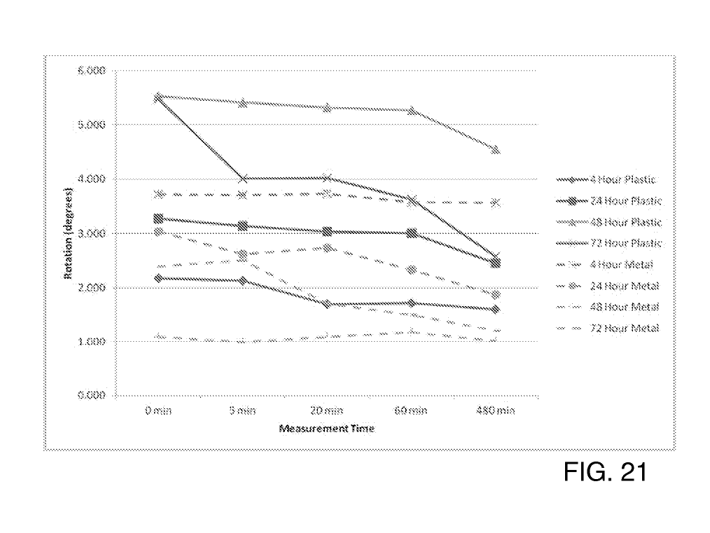

FIG. 21 are stress relaxation test results comparing identical razors (with razor cartridge on handle) one having a plastic rod (comprising Noryl 6120) compared to a metal rod (made of ¾ hard stainless steel). The rods had the same dimensions but only differed in their composition. The chart of FIG. 21 captures data for razors tested in an in use simulation environment, where the devices are wet.

Testing protocol—once the sample was ready it was placed in a fixture and held in position at about 15° rotation for various durations; 4 hours, 24 hours, 48 hours & 72 hours. Once removed from the fixtures the relaxation (ability of the rod to bias the connecting portion which holds the cartridge back to an original at rest potion) was measured immediately upon release (0 min) and then at 5 min, 20 min 60 min & 480 min.

Without intending to be bound by theory, it is believed that metal rods provide improved ability to return to the original position over various stress conditions. This is believed to be evidenced by 1) metal rod's initial readings being generally closer to the original at rest position, and 2) the difference in the slope of the curves. The Noryl 6120 samples are shown in solid line curves while metal samples are shown in dashed line curves. The slope of the metal rod curves are generally flatter than the plastic rod curves, suggesting that metal has preferred springback/stress relaxation. Essentially the products with metal springs returned back to their original position while considering measurement variability.

It should be understood that every maximum numerical limitation given throughout this specification includes every lower numerical limitation, as if such lower numerical limitations were expressly written herein. Every minimum numerical limitation given throughout this specification includes every higher numerical limitation, as if such higher numerical limitations were expressly written herein. Every numerical range given throughout this specification includes every narrower numerical range that falls within such broader numerical range, as if such narrower numerical ranges were all expressly written herein.

All parts, ratios, and percentages herein, in the Specification, Examples, and Claims, are by weight and all numerical limits are used with the normal degree of accuracy afforded by the art, unless otherwise specified.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”. All measurements are performed at 25° C., unless otherwise specified.

All documents cited in the DETAILED DESCRIPTION OF THE INVENTION are, in the relevant part, incorporated herein by reference; the citation of any document is not to be construed as an admission that it is prior art with respect to the present invention. To the extent that any meaning or definition of a term or in this written document conflicts with any meaning or definition in a document incorporated by reference, the meaning or definition assigned to the term in this written document shall govern. Except as otherwise noted, the articles “a,” “an,” and “the” mean “one or more.”

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A safety razor comprising:
a. a handle comprising a grip portion and a connection portion, said connection portion rotating with respect to said grip portion about a rotational axis, said connection portion forming a docking portion suitable for receiving an optional blade unit, said docking portion being positioned opposite distally away from said grip portion,
b. wherein the grip portion and the connection portion are connected by a single rod comprising a metal material, said rod comprising a distal end non-rotatably attached to the grip portion and a proximal end non-rotatably attached to the connection portion, wherein said rotational axis forms a central longitudinal axis of said rod.

2. The safety razor of claim 1, wherein the metal material is stainless steel.

3. The safety razor of claim 2, wherein the metal material is ¾ hardened stainless steel.

4. The safety razor of claim 1, wherein the metal material is selected from the group steel, stainless steel, X5CrNi18 10/X5CrNi18 8 (1.4301), X5CrNiMo17 13 3/X3CrNiMo17 13 3 (1.4436), X5CrNiMo171 12 2 (1.4401), X1NiCrMoCuN25 20 5 (1.4539), X7CrNiAl17 7 (1.4568), X6CrNiMoTi17 12 2 (1.4571), CuZn37 (CW508L; 2.0321), CuZn36 (CW507L; 2.0335), CuSn6 (CW452K; 2.1020), CuBe 2 (CW101C; 2.1247), NiMo16Cr16Ti (2.4610), NiCr15Fe7TiAI (2.4669), NiCr20Co18Ti (2.4632), Duratherm CoNiCrFe, VDC Oil tempered valve spring (1.1250; EN 10270-2), VDCrV Oil tempered valve spring (1.1250; EN 10270-2), VDSiCr Oil tempered valve spring (1.1250; EN 10270-2), and composites or laminates thereof.

5. The safety razor of claim 1, wherein the rod is permanently attached to at least one of said grip portion and said connection portion.

6. The safety razor of claim 1, wherein the end of the rod which is not permanently attached is removably attached to the other of said grip portion and said connection portion.

7. The safety razor of claim 1, wherein the rod is removably attached to both of said grip portion and said connection portion.

8. The safety razor of claim 1, wherein the rod further comprises a polymeric material.

9. The safety razor of claim 8, wherein said polymeric material is selected from the group consisting of: an acetal, a polyacetal, a polyoxymethylene, polyphenylene sulfide, a polyamide, a polybutylene terephthalate, a thermoplastic elastomer, a polyurethane, a silicone, a nitrile rubber, and a mixture thereof.

10. The safety razor of claim 1, wherein said rod comprises a first layer (462) laminated with a second layer (466).

11. The safety razor of claim 1, wherein said rod comprises a material having a Young's modulus of from about 0.01 GPa to about 200 GPa.

12. The safety razor of claim 1, wherein rotating said connection portion from a zero position by 15° generates from about 15 Nmm to about 40 Nmm of torque.

13. The safety razor of claim 1, wherein said rod comprises a body between said distal and proximal ends, and wherein said body is not a cylinder.

14. The safety razor of claim 1, wherein the blade unit pivots with respect to the connection member about a pivot axis substantially parallel to the at least one blade.

15. The safety razor of claim 1, wherein said blade unit comprises a guard, a cap, at least one blade positioned between the guard and the cap and a transverse centerline extending through the guard and the cap in a direction substantially perpendicular to the at least one blade.

16. The safety razor of claim 15, wherein the rotational axis intersects at least one of said pivot axis and said transverse centerline of the blade unit, preferably the transverse centerline.

17. The safety razor of claim 1, wherein said blade unit has a maximum rotation of about 15°.

18. The safety razor of claim 1, wherein the rod has a thickness of from about 0.1 mm to about 0.5 mm, preferably from about 0.2 mm to about 0.4 mm, preferably from about 0.30 mm to about 0.35 mm.

19. The safety razor of claim 1, wherein the rod has a length of from about 2 mm to about 4.5 mm, preferably from about 2.5 mm to about 4 mm, preferably from about 3 mm to about 3.8 mm.

20. The safety razor of claim 1, comprises a single rod made of metal material, wherein the rod is selected from the group consisting of 301 stainless steel ¾ hardened with a thickness of about 0.30 mm and a length of about 3.8 mm, or a 301 stainless steel ¾ hardened with a thickness of about 0.35 mm and a length of about 3.0 mm.
